(19) United States
(12) Patent Application Publication
(10) Pub. No.: US 2026/0186261 A1
(43) Pub. Date: Jul. 2, 2026

(54) IMAGING OPTICAL LENS

(71) Applicant: Changzhou AAC Raytech Optronics Co., Ltd., Changzhou City (CN)

(72) Inventor: Tingting Yang, Changzhou (CN)

(21) Appl. No.: 19/340,854

(22) Filed: Sep. 25, 2025

Related U.S. Application Data
(63) Continuation of application No. PCT/CN2024/144655, filed on Dec. 31, 2024.

(51) Int. Cl. G02B 13/00; G02B 9/64

(52) U.S. Cl. CPC G02B 13/0045; G02B 9/64

(57) ABSTRACT

An imaging optical lens, including, from an object side to an image side, first to seventh lenses; a focal length of the imaging optical lens is f, a total optical length of the imaging optical lens is TTL, a field of view of the imaging optical lens is FOV, a focal length of first lens is f1, a focal length of sixth lens is f6, a focal length of seventh lens is f7, a central curvature radius of an object-side surface of the third lens is R5, a central curvature radius of an image-side surface of third lens is R6, a central curvature radius of an object-side surface of the fourth lens is R7, and a central curvature radius of an image-side surface of the fourth lens is R8, where 2.40≤(f6−f7)/f1≤3.20; 0.90≤TTL/(f*tan(FOV/2))≤1.40; 0.30≤R5/R6≤0.80; −15.0≤(R7+R8)/(R7−R8)≤−1.50. The imaging optical lens has excellent optical characteristics, and large-aperture, wide-angle and ultra-thinness characteristics.

### TECHNICAL FIELD

The present disclosure relates to the field of optical lenses and, in particular, to an imaging optical lens suitable for handheld terminal equipment such as smart phones, digital cameras, and camera devices such as monitors and PC lenses

### BACKGROUND

In recent years, with the development of various smart devices, the demand for miniaturized imaging optical lenses has gradually increased. Since the pixel dimension of the photosensitive device is reduced, and the current electronic product has a development trend of high functionality and a slim and thin portable design. Therefore, miniaturized imaging optical lenses with good imaging quality have become the mainstream of the current market. In order to obtain better imaging quality, a multi-lenses structure is generally adopted. In addition, with the development of technology and the increase of diversified requirements of users, under the conditions that the pixel area of the photosensitive device continues to decrease and the requirement on the imaging quality of the system continues to increase, a seven-lenses structure has been gradually adopted in the lens design. There is an urgent need for a wide-angle camera lens having excellent optical characteristics with a small volume and fully corrected aberrations.

### SUMMARY

In view of the above problems, the main purpose of the present disclosure is to provide an imaging optical lens, which has good optical characteristics and meets design requirements of large-aperture, ultra-thinness and wide-angle design.

In order to achieve the above object, the technical solution of the present disclosure provides an imaging optical lens, including seven lenses, which are, from an object side to an image side, a first lens having a positive refractive power, a second lens having a negative refractive power, a third lens having a positive refractive power, a fourth lens having a negative refractive power, a fifth lens having a negative refractive power, a sixth lens having a positive refractive power, and a seventh lens having a negative refractive power; a focal length of the imaging optical lens is f, a total optical length of the imaging optical lens is TTL, a field of view of the imaging optical lens at 1.0 field of view is FOV, a focal length of the first lens is f1, a focal length of the sixth lens is f6, a focal length of the seventh lens is f7, a central curvature radius of an object-side surface of the third lens is R5, a central curvature radius of an image-side surface of the third lens is R6, a central curvature radius of an object-side surface of the fourth lens is R7, and a central curvature radius of an image-side surface of the fourth lens is R8, where

$$2.4 \leq ( f 6 - f 7 ) / f 1 \leq 3.2 ;$$

$$0.9 \leq TTL / ( f * tan ( FOV / 2 ) ) \leq 1.4 ;$$

$$0.3 \leq R 5 / R 6 \leq 0.8 ; and$$

$$- 15. \leq ( R 7 + R 8 ) / ( R 7 - R 8 ) \leq - 1.5 .$$

In an improvement, a following condition is satisfied:

$$1.1 \leq TTL / ( f * tan ( FOV / 2 ) ) \leq 1.4 .$$

In an improvement, a focal length of the third lens is f3, and a focal length of the fourth lens is f4, where

$$- 0.6 \leq f 3 / f 4 \leq - 0.25 .$$

In an improvement, an axial thickness of the first lens is d1, an axial distance from an image-side surface of the first lens to an object-side surface of the second lens is d2, and an axial thickness of the second lens is d3, where

$$0.15 \leq ( d 1 + d 2 + d 3 ) / TTL \leq 0.21 .$$

In an improvement, an object-side surface of the first lens is convex in a paraxial region, and an image-side surface of the first lens is concave in a paraxial region; and a central curvature radius of the object-side surface of the first lens is R1, a central curvature radius of the image-side surface of the first lens is R2, and an axial thickness of the first lens is d1, where

$$0.82 \leq f 1 / f \leq 0.89 ;$$

$$- 1.7 \leq ( R 1 + R 2 ) / ( R 1 - R 2 ) \leq - 1.24 ; and$$

$$0.09 \leq d 1 / TTL \leq 0.17 .$$

In an improvement, an object-side surface of the second lens is convex in a paraxial region, and an image-side surface of the second lens is concave in a paraxial region; and a focal length of the second lens is f2, a central curvature radius of the object-side surface of the second lens is R3, a central curvature radius of the image-side surface of the second lens is R4, and an axial thickness of the second lens is d3, where

$$- 3.1 \leq f 2 / f \leq - 2. ;$$

$$2.66 \leq ( R 3 + R 4 ) / ( R 3 - R 4 ) \leq 3.07 ; and$$

$$0.01 \leq d 3 / TTL \leq 0.07 .$$

In an improvement, the object-side surface of the third lens is convex in a paraxial region, and the image-side surface of the third lens is concave in a paraxial region; and a focal length of the third lens is f3, and an axial thickness of the third lens is d5, where

$$3.08 \leq f 3 / f \leq 12.92 ;$$

$$- 8.32 \leq ( R 5 + R 6 ) / ( R 5 - R 6 ) \leq - 1.84 ; and$$

$$0.03 \leq d 5 / TTL \leq 0.08 .$$

In an improvement, the object-side surface of the fourth lens is concave in a paraxial region, and the image-side surface of the fourth lens is convex in a paraxial region; and a focal length of the fourth lens is f4, and an axial thickness of the fourth lens is d7, where

$$- 21.53 \leq f 4 / f \leq - 7.1 ; and$$

$$0.02 \leq d 7 / TTL \leq 0.07 .$$

In an improvement, an image-side surface of the fifth lens is concave in a paraxial region; and a focal length of the fifth lens is f5, a central curvature radius of an object-side surface of the fifth lens is R9, a central curvature radius of the image-side surface of the fifth lens is R10, and an axial thickness of the fifth lens is d9, where

$$- 8.74 \leq f 5 / f \leq - 3.54 ;$$

$$0.23 \leq ( R 9 + R 10 ) / ( R 9 - R 10 ) \leq 2.26 ; and$$

$$0.03 \leq d 9 / TTL \leq 0.09 .$$

In an improvement, an object-side surface of the sixth lens is convex in a paraxial region; and a central curvature radius of the object-side surface of the sixth lens is R11, a central curvature radius of an image-side surface of the sixth lens is R12, and an axial thickness of the sixth lens is d11, where

$$1.16 \leq f 6 / f \leq 1.81 ;$$

$$- 1.27 \leq ( R 11 + R 12 ) / ( R 11 - R 12 ) \leq 0.13 ; and$$

$$0.07 \leq d 11 / TTL \leq 0.13 .$$

In an improvement, an object-side surface of the seventh lens is convex in a paraxial region, and an image-side surface of the seventh lens is concave in a paraxial region; and a central curvature radius of the object-side surface of the seventh lens is R13, a central curvature radius of the image-side surface of the seventh lens is R14, and an axial thickness of the seventh lens is d13, where

$$- 1.01 \leq f 7 / f \leq - 0.75 ;$$

$$1.12 \leq ( R 13 + R 14 ) / ( R 13 - R 14 ) \leq 1.18 ; and$$

$$0.05 \leq d 13 / TTL \leq 0.15 .$$

### BRIEF DESCRIPTION OF DRAWINGS

In order to better illustrate the technical solutions in the embodiments of the present disclosure, the accompanying drawings required to be used in the description of the embodiments will be briefly described below. Obviously, the accompanying drawings in the following description are only some embodiments of the present disclosure, and for those skilled in the art, other accompanying drawings may also be obtained according to these accompanying drawings without any creative effort.

FIG. 1 is a schematic structural diagram of an imaging optical lens according to a first embodiment of the present disclosure;

FIG. 2 is a schematic diagram of axial chromatic aberration of the imaging optical lens shown in FIG. 1;

FIG. 3 is a schematic diagram of lateral chromatic aberration of the imaging optical lens shown in FIG. 1;

FIG. 4 is a schematic diagram of field curvature and distortion of the imaging optical lens shown in FIG. 1;

FIG. 5 is a structural schematic diagram of an imaging optical lens according to a second embodiment of the present disclosure;

FIG. 6 is a schematic diagram of axial chromatic aberration of the imaging optical lens shown in FIG. 5;

FIG. 7 is a schematic diagram of lateral chromatic aberration of the imaging optical lens shown in FIG. 5;

FIG. 8 is a schematic diagram of field curvature and distortion of the imaging optical lens shown in FIG. 5;

FIG. 9 is a structural schematic diagram of an imaging optical lens according to a third embodiment of the present disclosure;

FIG. 10 is a schematic diagram of axial chromatic aberration of the imaging optical lens shown in FIG. 9;

FIG. 11 is a schematic diagram of lateral chromatic aberration of the imaging optical lens shown in FIG. 9; and

FIG. 12 is a schematic diagram of field curvature and distortion of the imaging optical lens shown in FIG. 9.

### DESCRIPTION OF EMBODIMENTS

In order to better illustrate objectives, technical solutions, and advantages of embodiments of the present disclosure, the technical solutions in embodiments of the present disclosure are described in details with reference to the accompanying drawings. It will be appreciated by those of ordinary skill in the art, in the various embodiments of the present disclosure, numerous technical details are provided to facilitate a better understanding of the present disclosure by the reader. However, even in the absence of these technical details and various modifications and variations based on the following embodiments, the technical solutions claimed by the present disclosure can still be implemented.

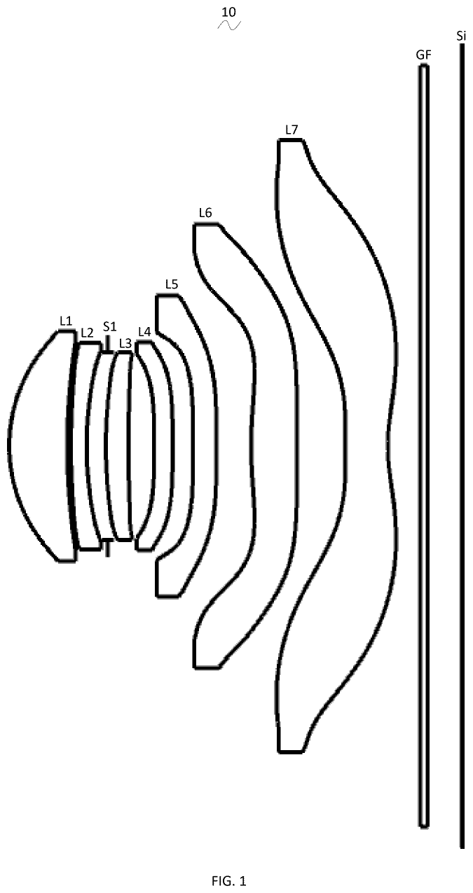

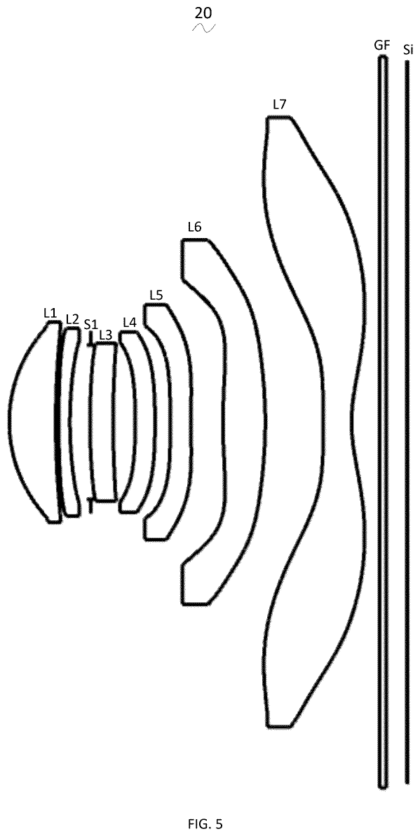

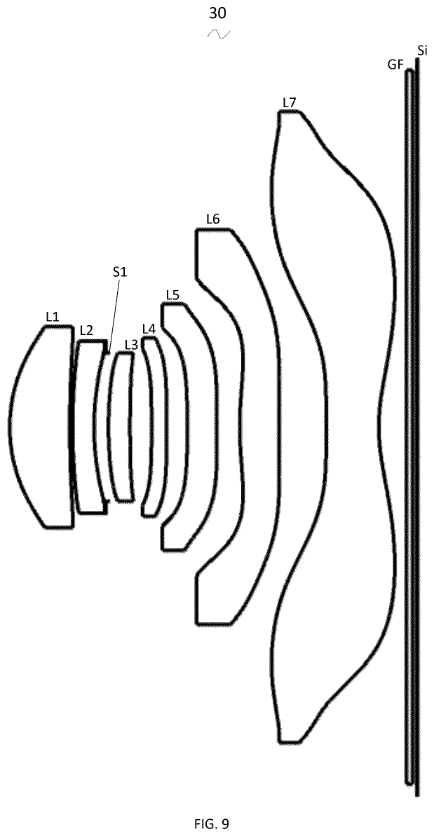

Referring to the drawings, a technical solution of the present disclosure provides imaging optical lenses 10, 20, and 30. FIG. 1, FIG. 5, and FIG. 9 show imaging optical lenses 10, 20, and 30 according to the present disclosure, and each of the imaging optical lenses 10, 20, and 30 includes seven lenses. In an example, the imaging optical lens includes, sequentially from an object side to an image side, a first lens L1, a second lens L2, an aperture S1, a third lens L3, a fourth lens L4, a fifth lens L5, a sixth lens L6, and a seventh lens L7. An optical element such as an optical filter GF may be disposed between the seventh lens L7 and an image surface Si.

The first lens L1 is made of plastic material, the second lens L2 is made of plastic material, the third lens L3 is made of plastic material, the fourth lens L4 is made of plastic material, the fifth lens L5 is made of plastic material, the sixth lens L6 is made of plastic material, and the seventh lens L7 is made of plastic material. Each of the lenses may be made of other material.

A focal length of the first lens L1 is defined as f1, a focal length of the sixth lens L6 is defined as f6, and a focal length of the seventh lens L7 is defined as f7, then it is satisfied that: 2.40≤(f6−f7)/f1≤3.20. By reasonably distributing the optical focal length of the system, the system has better imaging quality and lower sensitivity.

A total optical length of the imaging optical lens 10 is defined as TTL, a focal length of the imaging optical lens 10 is defined as f, and a field of view of the imaging optical lens 10 at 1.0 field of view is defined as FOV, then it is satisfied that: 0.90≤TTL/(f*tan (FOV/2))≤1.40, which helps to control the total length of the system when imaging with a large image surface. In some embodiments, then it is satisfied that: 1.10≤TTL/(f*tan (FOV/2))≤1.40.

A central curvature radius of an object-side surface of the third lens L3 is defined as R5, and a central curvature radius of an image-side surface of the third lens L3 is defined as R6, then it is satisfied that: 0.30≤R5/R≤30.80. The surface shape of the third lens is reasonably controlled, which is conducive to reducing the sensitivity of the system, improving the manufacturing yield by reducing the molding difficulty, and meanwhile, the stray light generated by the lens can be reduced, and the imaging quality of the lens can be improved.

A central curvature radius of an object-side surface of the fourth lens L4 is defined as R7, and a central curvature radius of an image-side surface of the fourth lens L4 is defined as R8, then it is satisfied that: −15.00≤(R7+R8)/(R7−R8)≤−1.50. The surface shape of the fourth lens is reasonably controlled, which can effectively balance the field curvature of the system, such that the field curvature deviation at the center field is less than 0.02 mm.

A focal length of the third lens L3 is defined as f3, and a focal length of the fourth lens L4 is defined as f4, then it is satisfied that: −0.60≤f3/f4≤−0.25. By reasonably distributing the optical focal lengths of adjacent lenses L3 and L4, a smooth transition of incident light can be achieved, such that the system has better imaging quality and lower sensitivity.

An axial thickness of the first lens is defined as d1, an axial distance from an image-side surface of the first lens to an object-side surface of the second lens is defined as d2, and an axial thickness of the second lens is defined as d3, then it is satisfied that: 0.15≤(d1+d2+d3)/TTL≤0.21, which specifies a ratio of the distance, from the object side of the first lens L1 to the image side of the second lens L2, to the total optical length of the system. By reasonably distributing the proportion of lens thicknesses, a smooth transition of incident light can be achieved, and the total optical length can be effectively shortened to achieve miniaturization.

When the above conditions are satisfied, the imaging optical lenses 10, 20, and 30 have good optical characteristics and can meet design requirements of large-aperture, wide-angle and ultra-thinness design. According to the characteristics of the imaging optical lenses 10, 20, and 30, the imaging optical lenses 10, 20, and 30 are particularly suitable for a mobile phone camera lens assembly consisting of camera elements such as CCD, CMOS for high pixels, and WEB camera lens.

Based on the above conditions and the implementable functions, the characteristics of each lens are further refined as follows.

An object-side surface of the first lens L1 is convex in a paraxial region, and an image-side surface of the first lens L1 is concave in a paraxial region. The first lens L1 has a positive refractive power. The object-side surface and the image-side surface of the first lens L1 may also be configured with other concave and convex arrangements.

A focal length of the first lens L1 is f1, a focal length of the imaging optical lens 10 is f, then it is satisfied that: 0.82≤f1/f≤0.89. Within the specified range, the first lens has a positive refractive power, which is conducive to reducing aberration of the system, and is also conducive to the development of the lens towards ultra-thinness and wide-angle design.

A central curvature radius of an object-side surface of the first lens L1 is R1, and a central curvature radius of an image-side surface of the first lens L1 is R2, then it is satisfied that: −1.70≤(R1+R2)/(R1−R2)≤−1.24. By reasonably controlling the shape of the first lens, the first lens can effectively correct the spherical aberration of the system.

An axial thickness of the first lens L1 is d1, and a total optical length of the imaging optical lens 10 is TTL, then it is satisfied that: 0.09≤d1/TTL≤0.17, which is conducive to achieving ultra-thinness.

An object-side surface of the second lens L2 is convex in a paraxial region, and an image-side surface of the second lens L2 is concave in a paraxial region. The second lens L2 has a negative refractive power. The object-side surface and the image-side surface of the second lens L2 may also be configured with other concave and convex arrangements.

A focal length of the second lens L2 is f2, and a focal length of the imaging optical lens 10 is f, then it is satisfied that: −3.10≤f2/f≤−2.00. By controlling the negative focal power of the second lens L2 within a reasonable range, it is conducive to correcting aberration of the optical system.

A central curvature radius of an object-side surface of the second lens L2 is R3, and a central curvature radius of an image-side surface of the second lens L2 is R4, then it is satisfied that: 2.66≤(R3+R4)/(R3−R4)≤3.07, which specifies the shape of the second lens L2. Within this range, with the development towards ultra-thinness and wide-angle design, it is conducive to correcting axial chromatic aberration.

An axial thickness of the second lens L2 is d3, and a total optical length of the imaging optical lens 10 is TTL, then it is satisfied that: 0.01≤d3/TTL≤0.07, which is conducive to achieving ultra-thinness.

An object-side surface of the third lens L3 is convex in a paraxial region, and an image-side surface of the third lens L3 is concave in a paraxial region. The third lens L3 has a positive refractive power. The object-side surface and the image-side surface of the third lens L3 may also be configured with other concave and convex arrangements.

A focal length of the third lens L3 is f3, and a focal length of the imaging optical lens 10 is f, then it is satisfied that: 3.08≤f3/f≤12.92. By reasonably distributing the focal power, the system has better imaging quality and lower sensitivity.

A central curvature radius of an object-side surface of the third lens L3 is R5, and a central curvature radius of an image-side surface of the third lens L3 is R6, then it is satisfied that: −8.32≤(R5+R6)/(R5−R6)≤−1.84, which can effectively control the shape of the third lens L3 and is conducive to the molding of the third lens L3. Within this condition range, the deflection of light passing through the lens can be alleviated, and the aberration can be effectively reduced.

An axial thickness of the third lens L3 is d5, and a total optical length of the imaging optical lens 10 is TTL, then it is satisfied that: 0.03≤d5/TTL≤0.08, which is conducive to achieving ultra-thinness.

An object-side surface of the fourth lens L4 is concave in a paraxial region, and an image-side surface of the fourth lens LA is convex in a paraxial region. The fourth lens L4 has a negative refractive power. The object-side surface and the image-side surface of the fourth lens L4 may also be configured with other concave and convex arrangements.

A focal length of the fourth lens L4 is f4, and a focal length of the imaging optical lens 10 is f, then it is satisfied that: −21.53≤f4/f≤−7.10. By reasonably distributing the focal power, the system has better imaging quality and lower sensitivity.

An axial thickness of the fourth lens L4 is d7, and a total optical length of the imaging optical lens 10 is TTL, then it is satisfied that: 0.02≤d7/TTL≤0.07, which is conducive to achieving ultra-thinness.

An object-side surface of the fifth lens L5 is convex or concave in a paraxial region, and an image-side surface of the fifth lens L5 is concave in a paraxial region. The fifth lens L5 has a negative refractive power. The object-side surface and the image-side surface of the fifth lens L5 may also be configured with other concave and convex arrangements.

A focal length of the fifth lens L5 is f5, and a focal length of the imaging optical lens 10 is f, then it is satisfied that: −8.74≤f5/f≤−3.54. The limitation on the fifth lens L5 may effectively make the light angle of the imaging lens moderate and reduce tolerance sensitivity.

A central curvature radius of an object-side surface of the fifth lens L5 is R9, and a central curvature radius of an image-side surface of the fifth lens L5 is R10, then it is satisfied that: 0.23≤(R9+R10)/(R9−R10)≤2.26, which specifies the shape of the fifth lens L5. Within this condition range, with the development towards ultra-thinness and wide-angle design, it is conducive to correcting aberration at off-axial field angles.

An axial thickness of the fifth lens L5 is d9, and a total optical length of the imaging optical lens 10 is TTL, then it is satisfied that: 0.03≤d9/TTL≤0.09, which is conducive to achieving ultra-thinness.

An object-side surface of the sixth lens L6 is convex in a paraxial region, and an image-side surface of the sixth lens L6 is convex or concave in a paraxial region. The sixth lens L6 has a positive refractive power. The object-side surface and the image-side surface of the sixth lens L6 may also be configured with other concave and convex arrangements.

A focal length of the sixth lens L6 is f6, and a focal length of the imaging optical lens 10 is f, then it is satisfied that: 1.16≤f6/f≤1.81. By reasonably distributing the focal power, the system has better imaging quality and lower sensitivity.

A central curvature radius of an object-side surface of the sixth lens L6 is R11, and a central curvature radius of an image-side surface of the sixth lens L6 is R12, then it is satisfied that: −1.27≤(R11+R12)/≤0.13, which specifies the shape of the sixth lens L6. Within this condition range, with the development towards ultra-thinness and wide-angle design, it is conducive to correcting aberration at off-axial field angles.

An axial thickness of the sixth lens L6 is d11, and a total optical length of the imaging optical lens 10 is TTL, then it is satisfied that: 0.07≤d11/TTL≤0.13, which is conducive to achieving ultra-thinness.

An object-side surface of the seventh lens L7 is convex in a paraxial region, and an image-side surface of the seventh lens L7 is concave in a paraxial region. The seventh lens L7 has a negative refractive power. The object-side surface and the image-side surface of the seventh lens L7 may also be configured with other concave and convex arrangements.

A focal length of the seventh lens L7 is f7, and a focal length of the imaging optical lens 10 is f, then it is satisfied that: −1.01≤f7/f≤−0.75. By reasonably distributing the focal power, the system has better imaging quality and lower sensitivity.

A central curvature radius of an object-side surface of the seventh lens L7 is R13, and a central curvature radius of an image-side surface of the seventh lens L7 is R14, then it is satisfied that: 1.12≤(R13+R14)/≤1.18, which specifies the shape of the seventh lens L7. Within this condition range, with the development towards ultra-thinness and wide-angle design, it is conducive to correcting aberration at off-axial field angles.

An axial thickness of the seventh lens L7 is d13, and a total optical length of the imaging optical lens 10 is TTL, then it is satisfied that: 0.05≤d13/TTL≤0.15, which is conducive to achieving ultra-thinness.

An image height at 1.0 field of view of the imaging optical lenses 10, 20, and 30 is IH, and a total optical length of the imaging optical lens 10 is TTL, then it is satisfied that: 1.10≤TTL/IH≤1.25, which is conducive to achieving ultra-thinness.

The field of view at 1.0 field of view of the imaging optical lenses 10, 20, and 30 satisfies 80° FOV≤85.60°, thereby achieving ultra-thinness.

An f-number FNO of the imaging optical lenses 10, 20, and 30 satisfies: 1.87≤FNO≤1.90, thereby achieving a large aperture, and ensuring the good imaging performance of the imaging optical lens.

The imaging optical lens according to the present disclosure will be described below with examples. The reference signs recited in each example are shown below. The units of focal length, axial distance, curvature radius, central curvature radius, and axial thickness are all millimeter (mm).

TTL: total optical length (an axial distance from an object-side surface of the first lens L1 to an image surface Si), with a unit of mm.

F-number FNO: a ratio of an effective focal length of the imaging optical lens to an entrance pupil diameter.

Image height IH at 1.0 field of view: height of a field of view corresponding to an active pixel of a sensor (that is, half of a diagonal length of an active pixel area of a sensor).

Field of view FOV at 1.0 field of view: a field of view corresponding to an active pixel of a sensor.

In some embodiments, the object-side surface and/or the image-side surface of the lens may also be provided with an inflection point and/or a standing point to, meet high-quality imaging requirements.

The technical solutions of the present disclosure are described below with reference to three embodiments, and the technical effects of the present disclosure cannot be achieved when exceeding the ranges defined by the above conditions.

### First Embodiment

Table 1 and Table 2 show design data of the imaging optical lens 10 according to the first embodiment of the present disclosure.

TABLE 1

| | R | d | | nd | | vd | |
|---|---|---|---|---|---|---|---|
| S1 | ∞ | d0= | −1.505 | | | | |
| R1 | 2.270 | d1= | 0.883 | nd1 | 1.5444 | ν1 | 55.82 |
| R2 | 8.860 | d2= | 0.057 | | | | |
| R3 | 10.268 | d3= | 0.240 | nd2 | 1.6797 | ν2 | 17.05 |
| R4 | 5.013 | d4= | 0.292 | | | | |
| R5 | 6.419 | d5= | 0.343 | nd3 | 1.5444 | ν3 | 55.82 |
| R6 | 14.459 | d6= | 0.397 | | | | |
| R7 | −15.456 | d7= | 0.280 | nd4 | 1.6700 | ν4 | 19.39 |
| R8 | −31.785 | d8= | 0.308 | | | | |
| R9 | 54.363 | d9= | 0.354 | nd5 | 1.6153 | ν5 | 25.94 |
| R10 | 20.843 | d10= | 0.533 | | | | |
| R11 | 5.629 | d11= | 0.699 | nd6 | 1.5661 | ν6 | 37.71 |
| R12 | 284.637 | d12= | 0.737 | | | | |
| R13 | 35.991 | d13= | 0.648 | nd7 | 1.5444 | ν7 | 55.82 |
| R14 | 2.444 | d14= | 0.500 | | | | |
| R15 | ∞ | d15= | 0.110 | ndg | 1.5168 | νg | 64.20 |
| R16 | ∞ | d16= | 0.519 | | | | |

The meanings of the various symbols are as follows.
S1: an aperture;
R: a curvature radius at a center of an optical surface, a center curvature radius of an object-side surface or an image-side surface of a lens;
R1: a central curvature radius of an object-side surface of a first lens L1;
R2: a central curvature radius of an image-side surface of a first lens L1;
R3: a central curvature radius of an object-side surface of a second lens L2;
R4: a central curvature radius of an image-side surface of a second lens L2;
R5: a central curvature radius of an object-side surface of a third lens L3;
R6: a central curvature radius of an image-side surface of a third lens L3;
R7: a central curvature radius of an object-side surface of a fourth lens L4;
R8: a central curvature radius of an image-side surface of a fourth lens L4;
R9: a central curvature radius of an object-side surface of a fifth lens L5;
R10: a central curvature radius of an image-side surface of a fifth lens L5;
R11: a central curvature radius of an object-side surface of a sixth lens L6;
R12: a central curvature radius of an image-side surface of a sixth lens L6;
R13: a central curvature radius of an object-side surface of a seventh lens L7;
R14: a central curvature radius of an image-side surface of a seventh lens L7;
R15: a curvature radius of an object-side surface of an optical filter GF;
R16: a curvature radius of an image-side surface of an optical filter GF;
d: an axial thickness of a lens, an axial distance between lenses;
d0: an axial distance from the aperture S1 to the object-side surface of the first lens L1;
d1: an axial thickness of the first lens L1;
d2: an axial distance from the image-side surface of the first lens L1 to the object-side surface of the second lens L2;
d3: an axial thickness of the second lens L2;
d4: an axial distance from the image-side surface of the second lens L2 to the object-side surface of the third lens L3;
d5: an axial thickness of the third lens L3;
d6: an axial distance from the image-side surface of the third lens L3 to the object-side surface of the fourth lens L4;
d7: an axial thickness of the fourth lens LA;
d8: an axial distance from the image-side surface of the fourth lens L4 to the object-side surface of the fifth lens L5;
d9: an axial thickness of the fifth lens L5;
d10: an axial distance from the image-side surface of the fifth lens L5 to the object-side surface of the sixth lens L6;
d11: an axial thickness of the sixth lens L6;
d12: an axial distance from the image-side surface of the sixth lens L6 to the object-side surface of the seventh lens L7;
d13: an axial thickness of the seventh lens L7;
d14: an axial distance from the image-side surface of the seventh lens L7 to the object-side surface of the optical filter GF;
d15: an axial thickness of the optical filter GF;
d16: an axial distance from the image-side surface of the optical filter GF to an image surface Si;
nd: a refractive index of d line (d line represents green light with a wavelength of 550 nm);
nd1: a refractive index of d line of the first lens L1;
nd2: a refractive index of d line of the second lens L2;
nd3: a refractive index of d line of the third lens L3;
nd4: a refractive index of d line of the fourth lens L4;
nd5: a refractive index of d line of the fifth lens L5;
nd6: a refractive index of d line of the sixth lens L6;
nd7: a refractive index of d line of the seventh lens L7;
ndg: a refractive index of d line of the optical filter GF;
vd: an Abbe number;
v1: an Abbe number of the first lens L1;
v2: an Abbe number of the second lens L2;
v3: an Abbe number of the third lens L3;
v4: an Abbe number of the fourth lens L4;
v5: an Abbe number of the fifth lens L5;
v6: an Abbe number of the sixth lens L6;
v7: an Abbe number of the seventh lens L7; and
vg: an Abbe number of the optical filter GF.

Table 2 shows aspherical surface data of each lens of the imaging optical lens 10 according to the first embodiment of the present disclosure.

TABLE 2

| | Conical | | | | | |
|---|---|---|---|---|---|---|
| | coefficient | Aspherical coefficient | | | | |
| | k | A4 | A6 | A8 | A10 | A12 |
| R1 | −6.0138E−01 | 3.9766E−03 | 9.3131E−03 | −2.5637E−02 | 6.1479E−02 | −1.1383E−01 |
| R2 | −2.6049E+00 | −6.0798E−03 | −3.2130E−02 | 2.1053E−01 | −6.4885E−01 | 1.3045E+00 |
| R3 | 1.3083E+01 | −1.9690E−02 | −8.6256E−03 | 1.5945E−01 | −5.6279E−01 | 1.2388E+00 |
| R4 | 2.1783E+00 | −1.4497E−02 | −1.2737E−02 | 1.3443E−01 | −4.3624E−01 | 8.2737E−01 |
| R5 | 1.8332E+01 | −2.3322E−02 | 2.7005E−02 | −1.5146E−01 | 5.0806E−01 | −1.0848E+00 |
| R6 | 8.6568E+01 | −2.1960E−02 | 5.9415E−02 | −3.4464E−01 | 1.2255E+00 | −2.8948E+00 |
| R7 | −9.8987E+01 | −4.7740E−02 | −3.3569E−02 | 3.4157E−01 | −1.9109E+00 | 6.6445E+00 |
| R8 | −9.9900E+01 | −5.7984E−02 | 5.6088E−02 | −1.0701E−01 | −3.3667E−02 | 7.7818E−01 |
| R9 | 9.9900E+01 | −7.7568E−02 | −3.6405E−02 | 5.2507E−01 | −1.9954E+00 | 4.6774E+00 |
| R10 | 4.9830E+01 | −1.0484E−01 | 1.0548E−01 | −1.8195E−01 | 3.0271E−01 | −3.7702E−01 |
| R11 | −3.9263E+01 | −2.1054E−02 | 1.7967E−02 | −4.2689E−02 | 4.7541E−02 | −3.4408E−02 |
| R12 | 9.1640E+01 | −2.1868E−02 | 2.9533E−02 | −3.6663E−02 | 2.7614E−02 | −1.4423E−02 |
| R13 | 5.2157E+01 | −1.4581E−01 | 8.3187E−02 | −3.7262E−02 | 1.2494E−02 | −3.0062E−03 |
| R14 | −1.1141E+01 | −7.2826E−02 | 3.7725E−02 | −1.6004E−02 | 5.2371E−03 | −1.3017E−03 |
| | Conical | | | | | |
| | coefficient | Aspherical coefficient | | | | |
| | k | A14 | A16 | A18 | A20 | A22 |
| R1 | −6.0138E−01 | 1.5628E−01 | −1.5587E−01 | 1.1220E−01 | −5.7995E−02 | 2.1266E−02 |
| R2 | −2.6049E+00 | −1.8385E+00 | 1.8693E+00 | −1.3885E+00 | 7.5402E−01 | −2.9596E−01 |
| R3 | 1.3083E+01 | −1.9047E+00 | 2.1209E+00 | −1.7330E+00 | 1.0393E+00 | −4.5187E−01 |
| R4 | 2.1783E+00 | −9.3271E−01 | 4.8890E−01 | 2.0195E−01 | −5.7888E−01 | 4.9565E−01 |
| R5 | 1.8332E+01 | 1.4395E+00 | −9.9257E−01 | −1.0868E−01 | 9.6319E−01 | −1.0111E+00 |
| R6 | 8.6568E+01 | 4.6287E+00 | −4.9276E+00 | 3.2248E+00 | −8.6367E−01 | −4.7776E−01 |
| R7 | −9.8987E+01 | −1.5804E+01 | 2.6612E+01 | −3.2171E+01 | 2.7984E+01 | −1.7347E+01 |
| R8 | −9.9900E+01 | −2.3383E+00 | 4.0112E+00 | −4.5437E+00 | 3.5486E+00 | −1.9265E+00 |
| R9 | 9.9900E+01 | −7.4954E+00 | 8.4941E+00 | −6.9120E+00 | 4.0510E+00 | −1.6940E+00 |
| R10 | 4.9830E+01 | 3.3511E−01 | −2.1333E−01 | 9.7896E−02 | −3.2347E−02 | 7.6050E−03 |
| R11 | −3.9263E+01 | 1.7099E−02 | −5.9807E−03 | 1.4870E−03 | −2.6257E−04 | 3.2581E−05 |
| R12 | 9.1640E+01 | 5.4061E−03 | −1.4727E−03 | 2.9304E−04 | −4.2467E−05 | 4.4237E−06 |
| R13 | 5.2157E+01 | 5.2378E−04 | −6.7136E−05 | 6.3835E−06 | −4.4942E−07 | 2.3113E−08 |
| R14 | −1.1141E+01 | 2.4307E−04 | −3.3772E−05 | 3.4615E−06 | −2.5898E−07 | 1.3909E−08 |

| | Conical | | | | |
|---|---|---|---|---|---|
| | coefficient | Aspherical coefficient | | | |
| | k | A24 | A26 | A28 | A30 |
| R1 | −6.0138E−01 | −5.3900E−03 | 8.9693E−04 | −8.8134E−05 | 3.8767E−06 |
| R2 | −2.6049E+00 | 8.1701E−02 | −1.5039E−02 | 1.6565E−03 | −8.2580E−05 |
| R3 | 1.3083E+01 | 1.3847E−01 | −2.8331E−02 | 3.4707E−03 | −1.9241E−04 |
| R4 | 2.1783E+00 | −2.4155E−01 | 7.1143E−02 | −1.1843E−02 | 8.5955E−04 |
| R5 | 1.8332E+01 | 5.7347E−01 | −1.9358E−01 | 3.6692E−02 | −3.0227E−03 |
| R6 | 8.6568E+01 | 5.8254E−01 | −2.6001E−01 | 5.8121E−02 | −5.3854E−03 |
| R7 | −9.8987E+01 | 7.4707E+00 | −2.1231E+00 | 3.5789E−01 | −2.7093E−02 |
| R8 | −9.9900E+01 | 7.1515E−01 | −1.7329E−01 | 2.4709E−02 | −1.5725E−03 |
| R9 | 9.9900E+01 | 4.9271E−01 | −9.4627E−02 | 1.0779E−02 | −5.5087E−04 |
| R10 | 4.9830E+01 | −1.2382E−03 | 1.3247E−04 | −8.3647E−06 | 2.3603E−07 |
| R11 | −3.9263E+01 | −2.7725E−06 | 1.5395E−07 | −5.0245E−09 | 7.3125E−11 |
| R12 | 9.1640E+01 | −3.2204E−07 | 1.5527E−08 | −4.4483E−10 | 5.7248E−12 |
| R13 | 5.2157E+01 | −8.4341E−10 | 2.0672E−11 | −3.0500E−13 | 2.0462E−15 |
| R14 | −1.1141E+01 | −5.2069E−10 | 1.2876E−11 | −1.8882E−13 | 1.2424E−15 |

For convenience, the aspherical surface of each lens is defined using the aspherical surface shown in Equation (1). However, the present disclosure is not limited to the aspherical polynomial form represented by Equation (1).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

In Equation (1), k represents a conical coefficient, A4, A6, A8, A10, A12, A14, A16, A18, A20, A22, A24, A26, A28, and A30 represent aspherical coefficients, c represents a curvature at a center of an optical surface, r represents a perpendicular distance between a point on a curved line of the aspherical surface and the optical axis, and z represents an aspherical depth (a perpendicular distance from a point, at a perpendicular distance r from the optical axis, on the aspherical surface to a tangent plane tangent to a vertex of the aspherical surface on the optical axis).

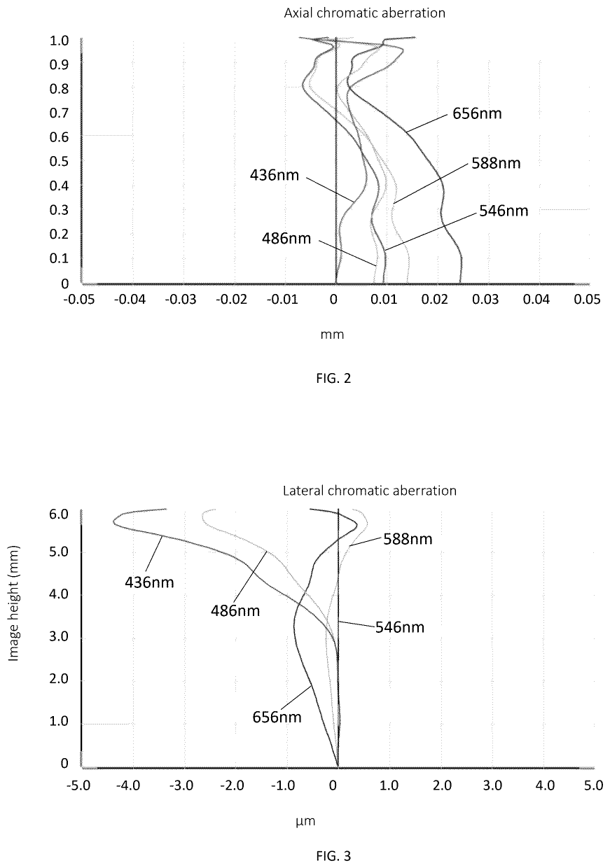

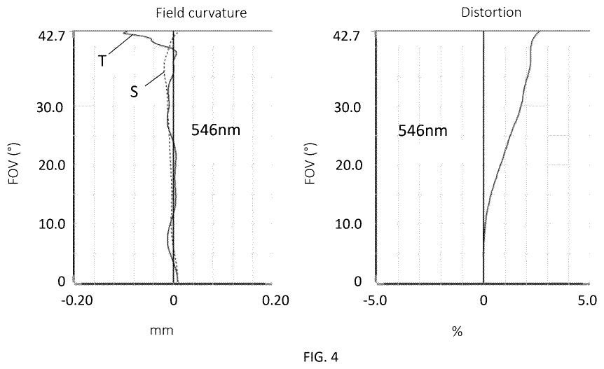

FIG. 2 and FIG. 3 respectively show axial chromatic aberration and lateral chromatic aberration of light with wavelengths of 656 nm, 588 nm, 546 nm, 486 nm and 436 nm after passing through the imaging optical lens 10 according to the first embodiment. FIG. 4 shows a schematic diagram of field curvature and distortion of the light with a wavelength of 546 nm after passing through the imaging optical lens 10 according to the first embodiment. The field curvature S in FIG. 4 is a field curvature in a sagittal direction, and T is a field curvature in a meridian direction.

In this embodiment, the entrance pupil diameter ENPD of the imaging optical lens 10 is 3.313 mm, the image height IH at 1.0 field of view is 6.000 mm, and the field of view FOV at 1.0 field of view is 85.45°. The imaging optical lens 10 meets the design requirements of large-aperture, wide-angle and ultra-thinness design, with the axial and off-axis chromatic aberrations thereof fully corrected, and exhibits excellent optical characteristics.

### Second Embodiment

The symbols used in the second embodiment have the same meanings as those in the first embodiment.

Different from the first embodiment, the image-side surface of the sixth lens L6 is convex in a paraxial region.

FIG. 5 shows an imaging optical lens 20 according to the second embodiment of the present disclosure.

Table 3 and Table 4 show design data of the imaging optical lens 20 according to the second embodiment of the present disclosure.

TABLE 3

| | R | d | | nd | | vd | |
|---|---|---|---|---|---|---|---|
| S1 | ∞ | d0= | −1.443 | | | | |
| R1 | 2.357 | d1= | 0.821 | nd1 | 1.5444 | ν1 | 55.82 |
| R2 | 13.589 | d2= | 0.050 | | | | |
| R3 | 12.231 | d3= | 0.200 | nd2 | 1.6797 | ν2 | 17.05 |
| R4 | 6.204 | d4= | 0.355 | | | | |
| R5 | 9.612 | d5= | 0.408 | nd3 | 1.5444 | ν3 | 55.82 |
| R6 | 12.244 | d6= | 0.394 | | | | |
| R7 | −9.938 | d7= | 0.348 | nd4 | 1.6700 | ν4 | 19.39 |
| R8 | −11.368 | d8= | 0.268 | | | | |
| R9 | 721.112 | d9= | 0.368 | nd5 | 1.6153 | ν5 | 25.94 |
| R10 | 13.047 | d10= | 0.565 | | | | |
| R11 | 8.968 | d11= | 0.749 | nd6 | 1.5661 | ν6 | 37.71 |
| R12 | −7.147 | d12= | 1.020 | | | | |
| R13 | 38.282 | d13= | 0.504 | nd7 | 1.5444 | ν7 | 55.82 |
| R14 | 2.598 | d14= | 0.500 | | | | |
| R15 | ∞ | d15= | 0.110 | ndg | 1.5168 | νg | 64.20 |
| R16 | ∞ | d16= | 0.383 | | | | |

Table 4 shows aspherical surface data of each lens of the imaging optical lens 20 according to the second embodiment of the present disclosure.

TABLE 4

| | Conical | | | | | |
|---|---|---|---|---|---|---|
| | coefficient | Aspherical coefficient | | | | |
| | k | A4 | A6 | A8 | A10 | A12 |
| R1 | −5.9738E−01 | 4.3349E−03 | 1.6893E−02 | −7.4641E−02 | 2.2202E−01 | −4.4463E−01 |
| R2 | −3.5917E+00 | −1.9302E−02 | 6.3507E−02 | −2.2333E−01 | 6.2597E−01 | −1.2414E+00 |
| R3 | 1.5226E+01 | −3.0619E−02 | 6.1850E−02 | −1.9640E−01 | 6.2915E−01 | −1.4728E+00 |
| R4 | 2.8175E+00 | −2.1332E−02 | 3.5065E−02 | −1.1491E−01 | 4.0662E−01 | −1.0485E+00 |
| R5 | 2.9873E+01 | −1.9924E−02 | 4.2321E−02 | −2.7585E−01 | 1.2990E+00 | −4.1911E+00 |
| R6 | 7.1400E+01 | −3.1205E−02 | 1.8062E−01 | −1.2179E+00 | 5.2475E+00 | −1.5401E+01 |
| R7 | −9.9900E+01 | −7.7356E−02 | 4.0409E−01 | −2.6276E+00 | 1.0966E+01 | −3.1416E+01 |
| R8 | −8.7367E+01 | −4.0846E−02 | 4.6346E−02 | −1.4472E−01 | 2.6086E−01 | −2.7028E−01 |
| R9 | −9.9900E+01 | −8.3422E−02 | 1.0034E−01 | −3.3695E−01 | 1.0982E+00 | −2.5276E+00 |
| R10 | −8.3335E−02 | −8.7255E−02 | 5.1496E−02 | −4.1943E−02 | 4.3967E−02 | −5.3674E−02 |
| R11 | −5.8112E+01 | −8.8125E−03 | −7.8554E−03 | 1.2343E−02 | −1.8420E−02 | 1.8397E−02 |
| R12 | −9.9900E+01 | −2.1531E−02 | 2.2848E−02 | −2.1243E−02 | 1.4130E−02 | −6.8857E−03 |
| R13 | 5.4779E+01 | −7.2088E−02 | 2.0681E−02 | −4.6715E−03 | 9.7918E−04 | −1.6577E−04 |
| R14 | −7.4378E+00 | −3.1406E−02 | 5.4098E−03 | 1.8519E−04 | −3.7746E−04 | 1.0582E−04 |
| | Conical | | | | | |
| | coefficient | Aspherical coefficient | | | | |
| | k | A14 | A16 | A18 | A20 | A22 |
| R1 | −5.9738E−01 | 6.2083E−01 | −6.1795E−01 | 4.4373E−01 | −2.3026E−01 | 8.5503E−02 |
| R2 | −3.5917E+00 | 1.7494E+00 | −1.7812E+00 | 1.3233E+00 | −7.1757E−01 | 2.8094E−01 |
| R3 | 1.5226E+01 | 2.4597E+00 | −2.9677E+00 | 2.6103E+00 | −1.6733E+00 | 7.7294E−01 |
| R4 | 2.8175E+00 | 1.9391E+00 | −2.6006E+00 | 2.5473E+00 | −1.8188E+00 | 9.3452E−01 |
| R5 | 2.9873E+01 | 9.5003E+00 | −1.5380E+01 | 1.7960E+01 | −1.5139E+01 | 9.1173E+00 |
| R6 | 7.1400E+01 | 3.1926E+01 | −4.7740E+01 | 5.2027E+01 | −4.1325E+01 | 2.3655E+01 |
| R7 | −9.9900E+01 | 6.3719E+01 | −9.3315E+01 | 9.9641E+01 | −7.7569E+01 | 4.3526E+01 |
| R8 | −8.7367E+01 | 4.3366E−02 | 3.1580E−01 | −5.2146E−01 | 4.5002E−01 | −2.4600E−01 |
| R9 | −9.9900E+01 | 4.0034E+00 | −4.4686E+00 | 3.5753E+00 | −2.0609E+00 | 8.4927E−01 |
| R10 | −8.3335E−02 | 5.4725E−02 | −4.0971E−02 | 2.1967E−02 | −8.3872E−03 | 2.2595E−03 |
| R11 | −5.8112E+01 | −1.2615E−02 | 6.0124E−03 | 2.0135E−03 | 4.7476E−04 | −7.8062E−05 |
| R12 | −9.9900E+01 | 2.4318E−03 | −6.2401E−04 | 1.1666E−04 | −1.5823E−05 | 1.5368E−06 |
| R13 | 5.4779E+01 | 2.0549E−05 | −1.8183E−06 | 1.1441E−07 | −5.0812E−09 | 1.5574E−10 |
| R14 | −7.4378E+00 | −1.6884E−05 | 1.7821E−06 | −1.3064E−07 | 6.7535E−09 | −2.4507E−10 |

| | Conical | | | | |
|---|---|---|---|---|---|
| | coefficient | Aspherical coefficient | | | |
| | k | A24 | A26 | A28 | A30 |
| R1 | −5.9738E−01 | −2.2144E−02 | 3.7981E−03 | −3.8773E−04 | 1.7839E−05 |
| R2 | −3.5917E+00 | −7.7354E−02 | 1.4215E−02 | −1.5661E−03 | 7.8259E−05 |
| R3 | 1.5226E+01 | −2.5045E−01 | 5.3996E−02 | −6.9543E−03 | 4.0471E−04 |
| R4 | 2.8175E+00 | −3.3597E−01 | 8.0061E−02 | −1.1339E−02 | 7.2092E−04 |
| R5 | 2.9873E+01 | −3.8225E+00 | 1.0592E+00 | −1.7426E−01 | 1.2885E−02 |
| R6 | 7.1400E+01 | −9.4993E+00 | 2.5388E+00 | −4.0546E−01 | 2.9275E−02 |
| R7 | −9.9900E+01 | −1.7137E+01 | 4.4910E+00 | −7.0334E−01 | 4.9800E−02 |
| R8 | −8.7367E+01 | 8.7901E−02 | −1.9955E−02 | 2.6153E−03 | −1.5060E−04 |
| R9 | −9.9900E+01 | −2.4412E−01 | 4.6507E−02 | −5.2775E−03 | 2.7006E−04 |
| R10 | −8.3335E−02 | −4.1989E−04 | 5.1278E−05 | −3.7077E−06 | 1.2038E−07 |
| R11 | −5.8112E+01 | 8.7315E−06 | −6.3185E−07 | 2.6634E−08 | −4.9613E−10 |
| R12 | −9.9900E+01 | −1.0405E−07 | 4.6659E−09 | −1.2469E−10 | 1.5061E−12 |
| R13 | 5.4779E+01 | −3.1342E−12 | 3.7181E−14 | −1.9404E−16 | −5.9291E−20 |
| R14 | −7.4378E+00 | 6.0943E−12 | −9.8577E−14 | 9.3022E−16 | −3.8631E−18 |

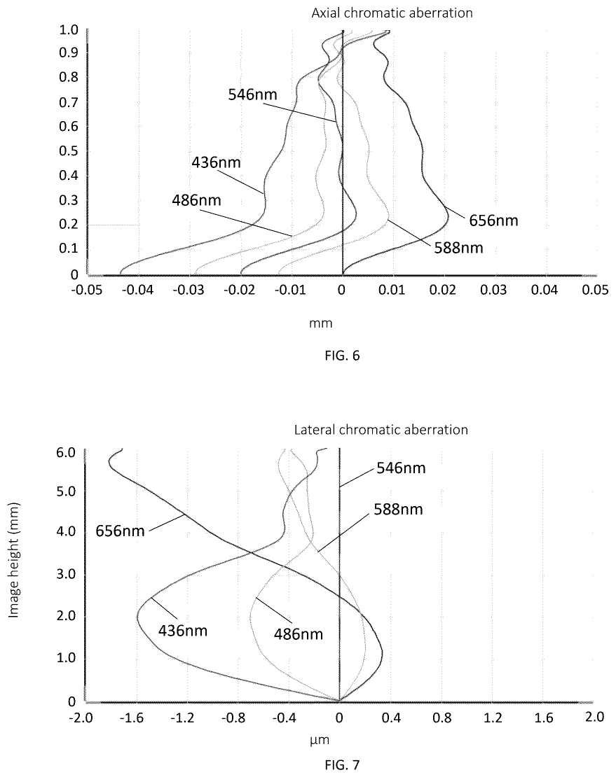

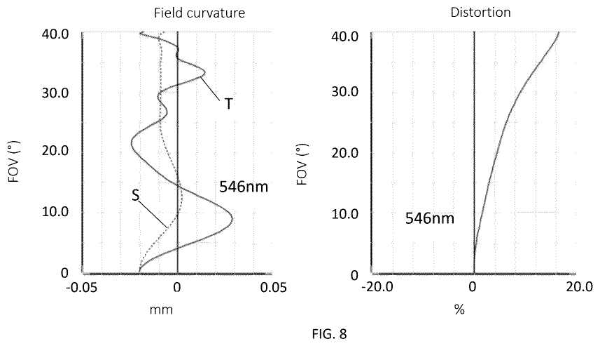

FIG. 6 and FIG. 7 respectively show axial chromatic aberration and lateral chromatic aberration of light with wavelengths of 656 nm, 588 nm, 546 nm, 486 nm and 436 nm after passing through the imaging optical lens 20 according to the second embodiment. FIG. 8 shows a schematic diagram of field curvature and distortion of the light with a wavelength of 546 nm after passing through the imaging optical lens 20 according to the second embodiment. The field curvature S in FIG. 8 is a field curvature in a sagittal direction, and T is a field curvature in a meridian direction.

In this embodiment, the entrance pupil diameter ENPD of the imaging optical lens 20 is 3.172 mm, the image height IH at 1.0 field of view is 6.000 mm, and the field of view FOV at 1.0 field of view is 80.21°. The imaging optical lens 20 meets the design requirements of large-aperture, wide-angle and ultra-thinness design, with the axial and off-axis chromatic aberrations thereof fully corrected, and exhibits excellent optical characteristics.

### Third Embodiment

The symbols used in the third embodiment have the same meanings as those in the first embodiment.

Different from the first embodiment, the object-side surface of the fifth lens L5 is concave in a paraxial region.

FIG. 9 shows the imaging optical lens 30 according to the third embodiment of the present disclosure.

Table 5 and Table 6 show design data of the imaging optical lens 30 according to the third embodiment of the present disclosure.

TABLE 5

| | R | d | | nd | | vd | |
|---|---|---|---|---|---|---|---|
| S1 | ∞ | d0= | −1.745 | | | | |
| R1 | 2.619 | d1= | 1.091 | nd1 | 1.5444 | ν1 | 55.82 |
| R2 | 22.220 | d2= | 0.050 | | | | |
| R3 | 10.230 | d3= | 0.390 | nd2 | 1.6856 | ν2 | 18.40 |
| R4 | 4.679 | d4= | 0.261 | | | | |
| R5 | 7.302 | d5= | 0.390 | nd3 | 1.5444 | ν3 | 55.82 |
| R6 | 24.179 | d6= | 0.391 | | | | |
| R7 | −39.869 | d7= | 0.272 | nd4 | 1.6700 | ν4 | 19.39 |
| R8 | −190.317 | d8= | 0.375 | | | | |
| R9 | −37.911 | d9= | 0.533 | nd5 | 1.6153 | ν5 | 25.94 |
| R10 | 22.766 | d10= | 0.419 | | | | |
| R11 | 5.559 | d11= | 0.716 | nd6 | 1.5661 | ν6 | 37.71 |
| R12 | 48.647 | d12= | 0.850 | | | | |
| R13 | 39.199 | d13= | 0.957 | nd7 | 1.5444 | ν7 | 55.82 |
| R14 | 3.029 | d14= | 0.500 | | | | |
| R15 | ∞ | d15= | 0.110 | ndg | 1.5000 | νg | 0.00 |
| R16 | ∞ | d16= | 0.093 | | | | |

Table 6 shows aspherical surface data of each lens of an imaging optical lens 30 according to the third embodiment of the present disclosure.

TABLE 6

| | Conical | | | | | |
|---|---|---|---|---|---|---|
| | coefficient | Aspherical coefficient | | | | |
| | k | A4 | A6 | A8 | A10 | A12 |
| R1 | −8.6062E−01 | 4.3852E−03 | 1.8747E−03 | −3.4158E−03 | 3.9516E−03 | −3.0453E−03 |
| R2 | 9.8188E+00 | −1.9759E−03 | 1.0820E−02 | −2.1291E−02 | 2.8398E−02 | −2.7192E−02 |
| R3 | 1.5530E+01 | −1.1591E−02 | 2.2101E−02 | −8.9398E−02 | 3.3683E−01 | −9.0717E−01 |
| R4 | 2.4607E+00 | −1.5425E−02 | 3.2950E−02 | −2.0114E−01 | 8.8901E−01 | −2.5745E+00 |
| R5 | 2.7129E+01 | −1.0322E−02 | 6.8959E−02 | −5.1850E−01 | 2.5306E+00 | −8.2699E+00 |
| R6 | 9.9900E+01 | 5.3938E−03 | −5.6216E−02 | 4.5110E−01 | −2.2095E+00 | 7.3435E+00 |
| R7 | −9.9900E+01 | −3.1954E−02 | 2.6734E−02 | −1.5193E−01 | 4.4648E−01 | −8.4598E−01 |
| R8 | 9.9900E+01 | −2.5064E−02 | −1.0979E−02 | 3.9262E−02 | −1.0362E−01 | 1.7107E−01 |
| R9 | −8.9157E+01 | −4.2272E−02 | 2.6426E−02 | −5.4334E−02 | 9.0193E−02 | −1.0373E−01 |
| R10 | 9.9900E+01 | −6.2003E−02 | 2.8917E−02 | −2.6359E−02 | 2.2926E−02 | −1.5114E−02 |
| R11 | −4.9654E+01 | −2.0131E−03 | −1.7408E−02 | 1.0694E−02 | −5.3828E−03 | 2.0193E−03 |
| R12 | 9.9900E+01 | −7.9102E−03 | −8.2948E−04 | −4.8497E−04 | 4.0742E−04 | −1.4064E−04 |
| R13 | 5.0044E+01 | −5.1010E−02 | 1.1082E−02 | −1.9163E−03 | 3.0452E−04 | −3.6790E−05 |
| R14 | −7.9549E+00 | −1.8905E−02 | 3.1131E−03 | −2.4340E−04 | −1.9047E−05 | 7.6357E−06 |
| | Conical | | | | | |
| | coefficient | Aspherical coefficient | | | | |
| | k | A14 | A16 | A18 | A20 | A22 |
| R1 | −8.6062E−01 | 1.5269E−03 | −5.0245E−04 | 1.0414E−04 | −1.2488E−05 | 6.6986E−07 |
| R2 | 9.8188E+00 | 1.7901E−02 | −7.8629E−03 | 2.1931E−03 | −3.5022E−04 | 2.4333E−05 |
| R3 | 1.5530E+01 | 1.7159E+00 | −2.3080E+00 | 2.2306E+00 | −1.5518E+00 | 7.6975E−01 |
| R4 | 2.4607E+00 | 5.0504E+00 | −6.8408E+00 | 6.4201E+00 | −4.1063E+00 | 1.7008E+00 |
| R5 | 2.7129E+01 | 1.8830E+01 | −3.0589E+01 | 3.5873E+01 | −3.0406E+01 | 1.8427E+01 |
| R6 | 9.9900E+01 | −1.7113E+01 | 2.8584E+01 | −3.4598E+01 | 3.0365E+01 | −1.9117E+01 |
| R7 | −9.9900E+01 | 1.0728E+00 | −9.1989E−01 | 5.2664E−01 | −1.9292E−01 | 4.0917E−02 |
| R8 | 9.9900E+01 | −1.8573E−01 | 1.3475E−01 | −6.4750E−02 | 1.9801E−02 | −3.4941E−03 |
| R9 | −8.9157E+01 | 7.7171E−02 | −3.6800E−02 | 1.0867E−02 | −1.8120E−03 | 1.3071E−04 |
| R10 | 9.9900E+01 | 6.7179E−03 | −1.9340E−03 | 3.4395E−04 | −3.4106E−05 | 1.4349E−06 |
| R11 | −4.9654E+01 | −5.5822E−04 | 1.0802E−04 | −1.3518E−05 | 9.7276E−07 | −3.0377E−08 |
| R12 | 9.9900E+01 | 2.9200E−05 | −3.7152E−06 | 2.8087E−07 | −1.1581E−08 | 2.0089E−10 |
| R13 | 5.0044E+01 | 3.0734E−06 | −1.7439E−07 | 6.6671E−09 | −1.6758E−10 | 2.6134E−12 |
| R14 | −7.9549E+00 | −1.0185E−06 | 8.1028E−08 | −4.2212E−09 | 1.4543E−10 | −3.1899E−12 |

| | Conical | | | | |
|---|---|---|---|---|---|
| | coefficient | Aspherical coefficient | | | |
| | k | A24 | A26 | A28 | A30 |
| R1 | −8.6062E−01 | 0.0000E+00 | 0.0000E+00 | 0.0000E+00 | 0.0000E+00 |
| R2 | 9.8188E+00 | 0.0000E+00 | 0.0000E+00 | 0.0000E+00 | 0.0000E+00 |
| R3 | 1.5530E+01 | −2.6548E−01 | 6.0467E−02 | −8.1747E−03 | 4.9665E−04 |
| R4 | 2.4607E+00 | −3.9490E−01 | 2.2410E−02 | 1.0528E−02 | −1.8296E−03 |
| R5 | 2.7129E+01 | −7.7756E+00 | 2.1669E+00 | −3.5794E−01 | 2.6494E−02 |
| R6 | 9.9900E+01 | 8.4084E+00 | −2.4519E+00 | 4.2571E−01 | −3.3302E−02 |
| R7 | −9.9900E+01 | −3.8260E−03 | 0.0000E+00 | 0.0000E+00 | 0.0000E+00 |
| R8 | 9.9900E+01 | 2.7139E−04 | 0.0000E+00 | 0.0000E+00 | 0.0000E+00 |
| R9 | −8.9157E+01 | 0.0000E+00 | 0.0000E+00 | 0.0000E+00 | 0.0000E+00 |
| R10 | 9.9900E+01 | 0.0000E+00 | 0.0000E+00 | 0.0000E+00 | 0.0000E+00 |
| R11 | −4.9654E+01 | 0.0000E+00 | 0.0000E+00 | 0.0000E+00 | 0.0000E+00 |
| R12 | 9.9900E+01 | 0.0000E+00 | 0.0000E+00 | 0.0000E+00 | 0.0000E+00 |
| R13 | 5.0044E+01 | −2.2252E−14 | 7.4005E−17 | 0.0000E+00 | 0.0000E+00 |
| R14 | −7.9549E+00 | 4.0249E−14 | −2.2175E−16 | 0.0000E+00 | 0.0000E+00 |

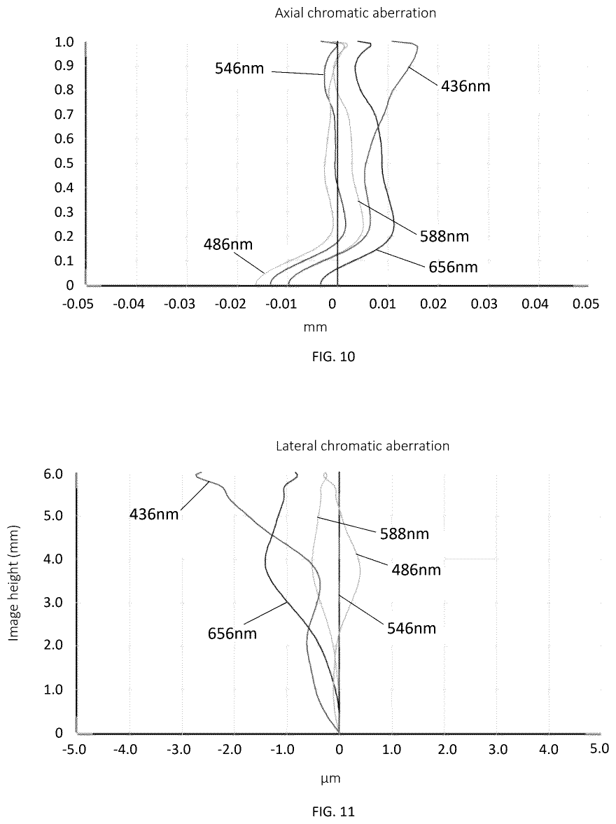

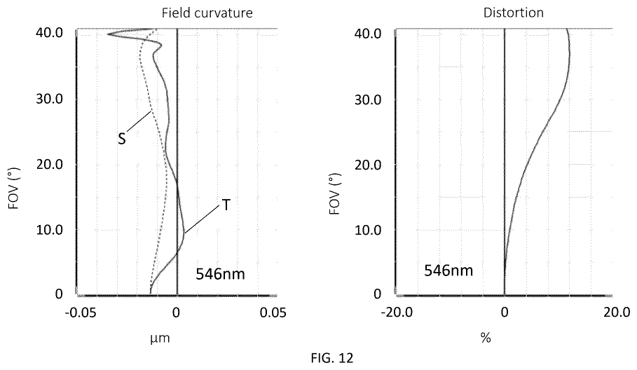

FIG. 10 and FIG. 11 respectively show axial chromatic aberration and lateral chromatic aberration of light with wavelengths of 656 nm, 588 nm, 546 nm, 486 nm and 436 nm after passing through the imaging optical lens 30 according to the third embodiment. FIG. 12 shows a schematic diagram of field curvature and distortion of the light with a wavelength of 546 nm after passing through the imaging optical lens 30 according to the third embodiment. The field curvature S in FIG. 12 is a field curvature in a sagittal direction, and T is a field curvature in a meridian direction.

In this embodiment, the entrance pupil diameter ENPD of the imaging optical lens 30 is 3.234 mm, the image height IH at 1.0 field of view is 6.000 mm, and the field of view FOV at 1.0 field of view is 81.69°. The imaging optical lens 30 meets the design requirements of large-aperture, wide-angle and ultra-thinness design, with the axial and off-axis chromatic aberrations thereof fully corrected, and exhibits excellent optical characteristics.

Table 11 below shows the various values in the first, second, and third embodiments corresponding to parameters defined in the conditions.

TABLE 7

| Parameters | First | Second | Third |
|---|---|---|---|
| and conditions | embodiment | embodiment | embodiment |
| (f6 − f7)/f1 | 2.80 | 2.41 | 3.19 |
| TTL/(f*tan(FOV/2)) | 1.19 | 1.39 | 1.40 |
| R5/R6 | 0.44 | 0.79 | 0.30 |
| (R7 + R8)/(R7 − R8) | −2.89 | −14.90 | −1.53 |
| f | 6.267 | 6.006 | 6.115 |
| f1 | 5.328 | 5.083 | 5.327 |
| f2 | −14.490 | −18.523 | −12.791 |
| f3 | 20.804 | 77.523 | 18.980 |
| f4 | −44.678 | −129.204 | −74.428 |
| f5 | −54.665 | −21.406 | −22.834 |
| f6 | 10.071 | 7.102 | 10.952 |
| f7 | −4.828 | −5.123 | −6.062 |
| FNO | 1.89 | 1.89 | 1.89 |
| TTL | 6.900 | 7.043 | 7.398 |
| IH | 6.000 | 6.000 | 6.000 |
| FOV | 85.45° | 80.21° | 81.69° |

Those of ordinary skill in the art should understand that the above embodiments are merely some embodiments of the present disclosure, and in practical applications, various modifications in form and detail may be made without departing from the spirit and scope of the present disclosure.

What is claimed is:

1. An imaging optical lens, comprising seven lenses, which are, from an object side to an image side, a first lens having a positive refractive power, a second lens having a negative refractive power, a third lens having a positive refractive power, a fourth lens having a negative refractive power, a fifth lens having a negative refractive power, a sixth lens having a positive refractive power, and a seventh lens having a negative refractive power;
wherein a focal length of the imaging optical lens is f, a total optical length of the imaging optical lens is TTL, a field of view of the imaging optical lens at 1.0 field of view is FOV, a focal length of the first lens is f1, a focal length of the sixth lens is f6, a focal length of the seventh lens is f7, a central curvature radius of an object-side surface of the third lens is R5, a central curvature radius of an image-side surface of the third lens is R6, a central curvature radius of an object-side surface of the fourth lens is R7, and a central curvature radius of an image-side surface of the fourth lens is R8, where
$$2.4 \leq ( f 6 - f 7 ) / fl \leq 3.2 ;$$
$$0.9 \leq TTL / ( f * tan ( F O V / 2 ) ) \leq 1.4 ;$$
$$0.3 \leq R 5 / R 6 \leq 0.8 ; and$$
$$- 15. \leq ( R 7 + R 8 ) / ( R 7 - R 8 ) \leq - 1.50 .$$

2. The imaging optical lens as described in claim 1, wherein a focal length of the third lens is f3, and a focal length of the fourth lens is f4, where
$$- 0.60 \leq f 3 / f 4 \leq - 0.25 .$$

3. The imaging optical lens as described in claim 1, wherein an axial thickness of the first lens is d1, an axial distance from an image-side surface of the first lens to an object-side surface of the second lens is d2, and an axial thickness of the second lens is d3, where
$$0.15 \leq ( d 1 + d 2 + d 3 ) / T T L \leq 0.21 .$$

4. The imaging optical lens as described in claim 1, wherein an object-side surface of the first lens is convex in a paraxial region, and an image-side surface of the first lens is concave in a paraxial region; and
a central curvature radius of the object-side surface of the first lens is R1, a central curvature radius of the image-side surface of the first lens is R2, and an axial thickness of the first lens is d1, where
$$0.82 \leq fl / f \leq 0.89 ;$$
$$- 1.7 \leq ( R 1 + R 2 ) / ( R 1 - R 2 ) \leq - 1 \text{.24} ; and$$
$$0.09 \leq d 1 / TTL \leq 0.17 .$$

5. The imaging optical lens as described in claim 1, wherein an object-side surface of the second lens is convex in a paraxial region, and an image-side surface of the second lens is concave in a paraxial region; and
a focal length of the second lens is f2, a central curvature radius of the object-side surface of the second lens is R3, a central curvature radius of the image-side surface of the second lens is R4, and an axial thickness of the second lens is d3, where
$$- 3.10 \leq f 2 / f \leq - 2. ;$$
$$2.66 \leq ( R 3 + R 4 ) / ( R 3 - R 4 ) \leq 3.07 ; and$$
$$0.01 \leq d 3 / TTL \leq 0.07 .$$

6. The imaging optical lens as described in claim 1, wherein the object-side surface of the third lens is convex in a paraxial region, and the image-side surface of the third lens is concave in a paraxial region; and
a focal length of the third lens is f3, and an axial thickness of the third lens is d5, where
$$3.08 \leq f 3 / f \leq 12.92 ;$$
$$- 8.3 \; 2 \leq ( R 5 + R 6 ) / ( R 5 - R 6 ) \leq - 1 \text{.84} ; and$$
$$0.03 \leq d 5 / TTL \leq 0.08 .$$

7. The imaging optical lens as described in claim 1, wherein the object-side surface of the fourth lens is concave in a paraxial region, and the image-side surface of the fourth lens is convex in a paraxial region; and
a focal length of the fourth lens is f4, and an axial thickness of the fourth lens is d7, where
$$- 21.53 \leq f 4 / f \leq - 7.1 ; and$$
$$0.02 \leq d 7 / TTL \leq 0.07 .$$

8. The imaging optical lens as described in claim 1, wherein an image-side surface of the fifth lens is concave in a paraxial region; and
a focal length of the fifth lens is f5, a central curvature radius of an object-side surface of the fifth lens is R9, a central curvature radius of the image-side surface of the fifth lens is R10, and an axial thickness of the fifth lens is d9, where
$$- 8.74 \leq f 5 / f \leq - 3.54 ;$$
$$0.23 \leq ( R 9 + R 10 ) / ( R 9 - R 10 ) \leq 2.26 ; and$$
$$0.03 \leq d 9 / TTL \leq 0.09 .$$

9. The imaging optical lens as described in claim 1, wherein an object-side surface of the sixth lens is convex in a paraxial region; and
a central curvature radius of the object-side surface of the sixth lens is R11, a central curvature radius of an image-side surface of the sixth lens is R12, and an axial thickness of the sixth lens is d11, where
$$1.16 \leq f 6 / f \leq 1.81 ;$$
$$- 1.27 \leq ( R 11 + R 12 ) / ( R 11 - R 12 ) \leq 0.13 ; and$$
$$0.07 \leq d 11 / TTL \leq 0.13 .$$

10. The imaging optical lens as described in claim 1, wherein an object-side surface of the seventh lens is convex in a paraxial region, and an image-side surface of the seventh lens is concave in a paraxial region; and
a central curvature radius of the object-side surface of the seventh lens is R13, a central curvature radius of the image-side surface of the seventh lens is R14, and an axial thickness of the seventh lens is d13, where
$$- 1.01 \leq f 7 / f \leq - 0.75 ;$$
$$1.12 \leq ( R 13 + R 14 ) / ( R 13 - R 14 ) \leq 1.18 ; and$$
$$0.05 \leq d 13 / TTL \leq 0.15 .$$

11. The imaging optical lens as described in claim 1, wherein a following condition is satisfied:
$$1.1 \leq TTL / ( f * tan ( FOV / 2 ) ) \leq 1.4 .$$
